(19) United States
(12) Patent Application Publication
(10) Pub. No.: US 2024/0361165 A1
(43) Pub. Date: Oct. 31, 2024

(54) METHOD FOR DETECTING BUBBLES OR DROPLETS OF A FIRST MEDIUM IN A FLUID SECOND MEDIUM FLOWING THROUGH A MEASURING PIPE

(71) Applicant: Innovative Sensor Technology IST AG, Ebnat-Kappel (CH)

(72) Inventors: Ralf Emanuel Bernhardsgrütter, Sulgen (CH); Jürgen Dorsch, Ebnat-Kappel (CH); Christoph Hepp, Wil (CH)

(21) Appl. No.: 18/687,357

(22) PCT Filed: Aug. 10, 2022
(86) PCT No.: PCT/EP2022/072451

§ 371 Date: Feb. 28, 2024

(30) Foreign Application Priority Data
Sep. 2, 2021 (DE) 10 2021 122 790.9

(51) Int. Cl. G01F 1/69; G01F 1/688

(52) U.S. Cl. CPC G01F 1/69; G01F 1/6888

(57) ABSTRACT

A method for detecting bubbles or droplets of a first medium in a fluid second medium flowing through a measuring pipe includes: heating a first heating element and a second heating element, which are each arranged on the measuring pipe and at a distance from each other; simultaneously sensing a first ambient temperature at the first heating element by a first sensor and a second ambient temperature at the second heating element by a second sensor; determining a first variable of the first sensor corresponding to the first ambient temperature and a second variable of the second sensor corresponding to the second ambient temperature; forming a difference between the first variable and the second variable; and comparing an absolute value of the difference with a reference threshold value, wherein the presence of a bubble or droplet is detected when the absolute value at least briefly exceeds the reference threshold value.

The invention relates to a method for detecting bubbles or droplets of a first medium in a fluid second medium flowing through a measuring pipe, wherein a first heating element is arranged on the measuring pipe at a first measuring point, wherein a second heating element is arranged on the measuring pipe at a second measuring point, wherein the second measuring point is arranged at a distance from the first measuring point in the direction of flow. The invention further relates to a sensor arrangement for carrying out the method according to the invention.

Thermal flow sensors are known for determining a flow rate or the flow velocity of a measuring medium, or a fluid, e.g., a gas, a gas mixture, or a liquid. These make use of the fact that a (flowing) measuring medium transports heat away from a heated surface. Thermal flow sensors are typically composed of several functional elements, usually at least one low-impedance heating element and one high-impedance resistance element, which serve as a temperature sensor. Alternatively, thermal flow sensors are composed of several low-impedance heating elements, serving as heaters and temperature sensors.

Calorimetric thermal flow sensors determine the flow or flow rate of the fluid in a channel by way of a temperature difference between two temperature sensors, which are arranged downstream and upstream of a heating element. For this purpose, use is made of the fact that, up to a certain point, the temperature difference is linear with respect to the flow or the flow rate. This procedure or method is described extensively in the relevant literature.

Anemometric thermal flow sensors consist of at least one heating element, which is heated during the measurement of the flow. As a result of the measuring medium flowing around the heating element, heat transport into the measuring medium takes place, which changes with the flow velocity. The flow velocity of the measuring medium can be inferred by measuring the electrical variables of the heating element.

Such an anemometric thermal flow sensor is typically operated in one of the following two control types:

In the “constant current anemometry” (CCA) control type, a constant current is applied to the heating element. The measuring medium flowing around causes the resistance of the heating element to change, and thus the voltage to drop at the heating element, which represents the measuring signal. The “constant voltage anemometry” (CVA) control type functions similarly thereto, with a constant voltage being applied to the heating element.

In the “constant temperature anemometry” (CTA) control type, the heating element is maintained at a temperature that, on average, is constant. Relatively high flow velocities can be measured by means of this control type. Depending upon the flow velocity, more or less heat is transported away by means of the flowing measuring medium, and, accordingly, more or less electrical power must be fed in in order to keep the temperature constant. This fed-in electrical power is a measure of the flow velocity of the measuring medium.

However, bubbles or droplets in the measurement medium can influence the informativeness and accuracy of the flow velocity measurement. There are various systems available on the market today that are used to detect bubbles or droplets. These are based for example on ultrasound measurement or on optical measurement.

The disadvantage of these systems is that these are additional components to be fastened to or in the pipe. In addition, (partially) transparent pipes must be used for the optical measurement, which rules out the use of metal pipes.

Based on this problem, the invention is based on the object of providing an alternative possibility for detecting anomalies, in particular bubbles or drops, in a pipe, which overcomes the above-mentioned disadvantages.

The object is achieved by a method according to claim 1 and by a sensor arrangement according to claim 4.

With regard to the method, it is provided that this method is used to detect bubbles or droplets of a first medium in a fluid second medium flowing through a measuring pipe, wherein a first heating element is arranged on the measuring pipe at a first measuring point, wherein a second heating element is arranged on the measuring pipe at a second measuring point, wherein the second measuring point is arranged at a distance from the first measuring point in the direction of flow, comprising:
heating the first heating element and the second heating element by means of electrical power,
simultaneously sensing the ambient temperature at the first measuring point by means of a first temperature sensor and the ambient temperature at the second measuring point by means of a second temperature sensor, wherein a first electrical measured variable of the first temperature sensor is determined to sense the ambient temperature at the first measuring point and wherein a second electrical measured variable of the second temperature sensor is determined to sense the ambient temperature at the second measuring point,
forming a difference between the first electrical measured variable and the second electrical measured variable, and
comparing the absolute value of the difference to a reference threshold value, wherein the presence of a bubble or a droplet is detected if the absolute value of the difference at least briefly exceeds the reference threshold value.

The method according to the invention makes it possible to detect bubbles or droplets of a first medium in a second medium on the basis of the thermal principle. Two heating elements are required for this purpose. These can, for example, be part of an already-installed thermal flow sensor.

The method enables detection independent of the flow velocity of the second medium. Even changing flow velocities during the measurement do not impair the measurement, as the difference between the determined electrical measured variables, which provides direct information about the temperature at the relevant measuring point, is always formed. A changing flow velocity has a direct effect on the ambient temperature at both measuring points, so that this change is reduced by forming the difference. This can be carried out in an analog or digital manner.

Physical phase boundary surfaces are referred to as bubbles or droplets. In this context, a bubble is a gaseous body (first medium) within a liquid (second medium). A liquid body (first medium) within a liquid (first medium) or a gas (second medium) is referred to as a droplet.

The ambient temperature of the measuring point designates the temperature in the region directly adjacent to the respective temperature sensor. This is substantially determined by the first or second medium.

Advantageously, the dimension or size of the droplets or bubbles can be deduced from the size of the absolute value of the difference. However, the flow velocity of the second medium has to be known for this purpose.

According to an advantageous embodiment of the method according to the invention, it is provided that the first electrical measured variable is a first voltage dropping across the first temperature sensor and/or a first current value flowing through the first temperature sensor, and wherein the second electrical measured variable is a second voltage dropping across the second temperature sensor and/or a second current value flowing through the second temperature sensor. Advantageously, both physical measured variables correspond to the same type, for example in each case voltage, current, etc. However, it is also possible for both physical measured variables to correspond to different (analog) types and to be offset to fit each other by means of digitization.

According to an advantageous embodiment of the method according to the invention, it is provided that a time between a change in the first measured variable and a corresponding change in the second measured variable is detected, wherein a flow rate of the bubble or of the droplet and/or the flow direction of the fluid second medium and/or of the bubble or of the droplet is determined on the basis of the detected time and a known distance between the first measuring point and the second measuring point. The flow velocity of the fluid second medium can be derived from the flow velocity of the bubble or of the droplet. Since the measured variables do not change simultaneously, but rather in a manner depending on the time of passage of the bubble or droplet, it is possible to determine which measuring point the bubble or the droplet passed first. The flow direction of the fluid second medium, or of the bubble or of the droplet, can be derived from this.

With regard to the sensor arrangement, it is provided that it comprises a measuring pipe, a first heating element, a second heating element, a first temperature sensor, a second temperature sensor and a control/evaluation unit, wherein the control/evaluation unit is designed to control the first heating element, the second heating element, the first temperature sensor, and the second temperature sensor in such a way that the method according to the invention is carried out. For example, a thermal flow sensor can be used which has the required components.

An advantageous embodiment of the sensor arrangement according to the invention provides that the first temperature sensor is operated as first heating element, wherein the second temperature sensor is operated as second heating element.

According to an advantageous embodiment of the sensor arrangement according to the invention, it is provided that the first heating element and the first temperature sensor are separate elements, and wherein the second heating element and the second temperature sensor are separate elements. All, or some individual ones, of these heating elements and temperature sensors can be arranged on a common substrate or a plurality of individual substrates, or alternatively can be applied directly on the measuring pipe, e.g., using a thick-film or thin-film technique.

According to an advantageous embodiment of the sensor arrangement according to the invention, it is provided that the first heating element and the second heating element or the first temperature sensor and the second temperature sensor are PCT or NTC resistor elements, in particular made of platinum.

If the heating elements and the temperature sensors are separate elements, heating elements can also be used that comprise a material with a temperature coefficient of 0 ppm/K, which satisfies the temperature dependence of the separate temperature sensors.

Alternatively, it is provided that the first temperature sensor and the second temperature sensor are thermocouples.

According to an advantageous embodiment of the sensor arrangement according to the invention, it is provided that the first temperature sensor is identical in design to the second temperature sensor.

Alternatively, the temperature sensors can also have different designs. However, the corresponding deviations and their metrological effects must then be known and compensated for if necessary.

An advantageous embodiment of the sensor arrangement according to the invention provides that the first temperature sensor is identical in design to the second temperature sensor.

Alternatively, the heating elements can also have different designs. However, the corresponding deviations and their metrological effects must then be known and compensated for if necessary.

An advantageous embodiment of the sensor arrangement according to the invention provides that the first temperature sensor and the second temperature sensor are arranged in a bridge circuit, wherein a first resistor is connected in series upstream of the first temperature sensor and wherein a second resistor is connected in series upstream of the second temperature sensor, wherein the first resistor and the second resistor are identical in design.

Alternatively, both physical measured variables can be detected separately in digital form (for example using an analog-to-digital converter) and the difference can then be formed digitally. According to an advantageous embodiment of the sensor arrangement according to the invention, it is provided that the measuring pipe is made of an optically non-transparent, in particular metallic, material. In contrast to the established and known measuring method for bubble detection based on ultrasound, the sensor arrangement or method according to the invention can also be used in metallic measuring pipes. Of course, other suitable materials or even transparent materials can be used for the measuring pipe in addition to metallic materials.

According to an advantageous embodiment of the sensor arrangement according to the invention, it is provided that the first heating element, the second heating element, the first temperature sensor, and the second temperature sensor, or the first temperature sensor operated as a first heating element and the second temperature sensor operated as a second heating element, are arranged on the outer wall of the measuring pipe.

According to an advantageous alternative embodiment of the sensor arrangement according to the invention, it is provided that the first heating element, the second heating element, the first temperature sensor and the second temperature sensor, or the first temperature sensor operated as the first heating element and the second temperature sensor operated as the second heating element, are arranged inside the measuring pipe. Inside the measuring pipe means that the second heating element, the first temperature sensor and the second temperature sensor, or the first temperature sensor operated as the first heating element and the second temperature sensor operated as the second heating element, can for example be attached to or on the inner wall of the measuring pipe. Alternatively, it is also possible, for example, for the second heating element, the first temperature sensor and the second temperature sensor, or the first temperature sensor operated as the first heating element and the second temperature sensor operated as the second heating element, to be inserted into the measuring pipe and, for example, to be offset from the inner wall of the measuring pipe.

Alternatively, the measuring points can also be designed differently—for example, the first measuring point (and the corresponding first heating element and/or the corresponding first temperature sensor) can be located outside the measuring pipe, while the second measuring point (and the corresponding second heating element and/or the corresponding second temperature sensor) is located inside the measuring pipe, and vice versa.

The invention is explained in greater detail with reference to the following figures. In the figures:

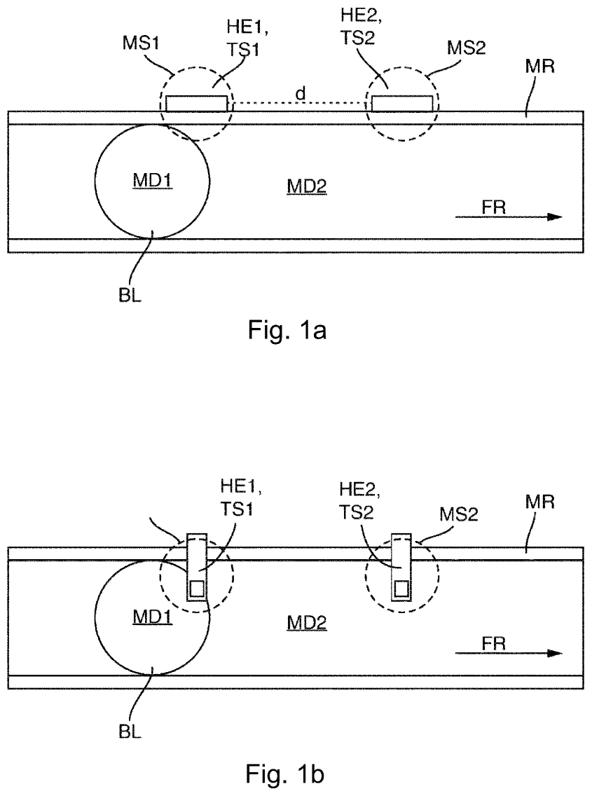

FIG. 1: shows a schematic representation of two exemplary applications of sensor arrangements according to the invention;

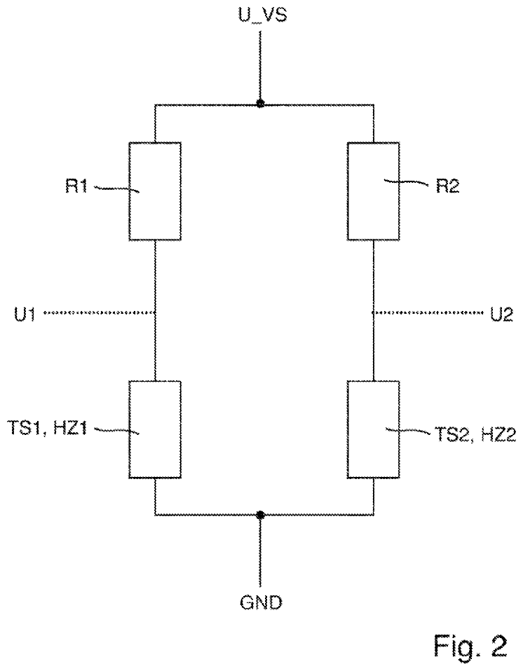

FIG. 2: shows a schematic circuit diagram illustrating the measuring principle of the sensor arrangement according to the invention;

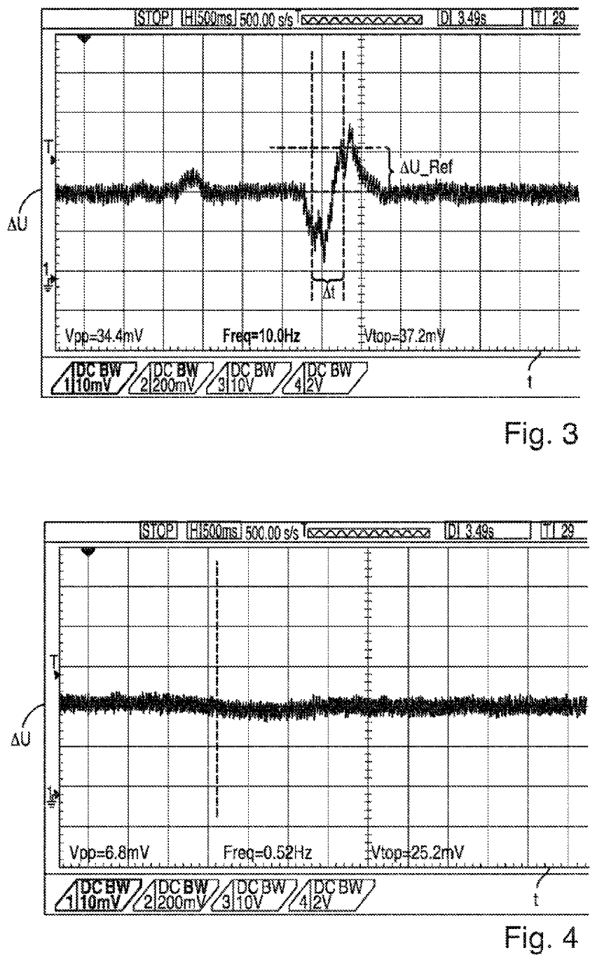

FIG. 3: shows a graph showing a first curve of the difference in the electrical measured variables; and

FIG. 4: shows a further graph showing a second curve of the difference between the electrical measured variables.

FIG. 1 shows two exemplary designs or applications of sensor arrangements designed to carry out the method according to the invention.

FIG. 1a) shows a metallic measuring pipe MR, for example made of chromium steel, through which a fluid second medium MD2, for example water, flows in the flow direction FR. To detect bubbles BL that may be present of a second medium, for example air bubbles, a first temperature sensor TS1 is attached to the outer wall of the measuring pipe MR at the position of a first measuring point MS1 and a second temperature sensor TS2 is attached to the outer wall of the measuring pipe at the position of a second measuring point MS2. The temperature sensors TS1, TS2 are two platinum elements (e.g., PT50) that are applied to a substrate using thin-film technology. As an alternative to platinum elements, thermocouples could also be used.

By an input of electrical current into the temperature sensors TS1, TS2, these can be used as heating elements HZ1, HZ2 for emitting electrical energy. These are therefore each single elements that can be operated as a temperature sensor and as a heating element.

Alternatively, it can be provided that the temperature sensors TS1, TS2 and the heating elements HZ1, HZ2 are individual elements, i.e., are attached separately from each other at the position of the respective measuring points MS1, MS2.

The heating elements HZ1, HZ2 or temperature sensors TS1, TS2 are to be coupled as well as possible with the second fluid medium MD2. Methods for attachment to the measuring pipe and example structures of the heating elements/temperature sensors for improving the heat transfer from heating element HZ1, HZ2 to the second medium MD2, or from the second medium to the temperature sensors TS1, TS2 are disclosed in DE 10 2016 116101 A1 or in DE 10 2018 130547 A1.

The distance between the two measuring points MS1, MS2 depends on the size of the heating elements HZ1, HZ2, the diameter of the measuring pipe MR1, and the average bubble or droplet size to be expected. A symmetrical design of the heating elements HZ1, HZ2 or the temperature sensors TS1, TS2 in terms of physical parameters (e.g., electrical resistance value) simplifies the controlling of the sensor arrangement and the evaluation of the measured variables U1, U2.

FIG. 1b) shows an alternative design of the sensor arrangement according to the invention. Here, the heating elements HZ1, HZ or the temperature sensors TS1, TS2 (here as well each either as a common element or as individual elements) are designed as rods or ceramic plates, possibly surrounded by a protective sheath (thermowell) and are attached inside the measuring pipe MR and contact the second medium MD2 directly. In this exemplary embodiment, a high degree of sensitivity is achieved. A disadvantage is that the temperature sensors TS1, TS2 or the heating elements HZ1, HZ2 could be damaged by contact with the second medium MD2 and/or could influence the flow of the second medium MD2, e.g., by generating turbulence.

To detect the bubbles BL, the two heating elements HZ1, HZ2 are supplied with electrical current. An exemplary circuit diagram is shown in FIG. 2 if the heating elements HZ1, HZ2 and the temperature sensors TS1, TS2 are each designed as a common element.

An electrical resistor R1, R2 is connected upstream of each of the heating elements/temperature sensors, resulting in a full bridge. By applying a supply voltage U_VS, the By supplying electrical current, the heating elements HZ1, HZ2 emit heat to the immediate surroundings of the first measuring point MS1 and the second measuring point MS2. For the person skilled in the art, it goes without saying that further circuit/measurement types can also be used, for example half-bridges or a digital detection of the two physical measured variables.

The voltage U1, which is present in the voltage divider between the resistor R1 and the first temperature sensor TS1, and the voltage U2, which is present in the voltage divider between the resistor R1 and the first temperature sensor TS1, are each detected as electrical measured variables immediately or during the application of the electrical current.

The heat emitted by the heating elements HZ1, HZ2 is dissipated differently depending on the nature of the second medium MD2 and the flow velocity. That is (assuming a constant heating power) the temperature at each of the heating elements HZ1, HZ2 and in the immediate vicinity of the heating elements HZ1, HZ2 is different. The voltage across the temperature sensor TS1, TS2 thus changes depending on the flow velocity and the physical properties of the second medium MD2. If a bubble BL, consisting of the first measuring medium (air in this example), passes a measuring point MS1, MS2, the heat dissipation consequently changes in the short term, because the physical properties of the second measuring medium change in the short term. However, the same effect is achieved if the flow velocity changes.

According to the invention, the difference ΔU between the voltage U1 and the voltage U2 is now formed and recorded. As a result, passing bubbles BL can be clearly distinguished from a change in the flow velocity.

These phenomena are illustrated in FIG. 3 (change in the difference ΔU when a bubble passes both measuring points MS1, MS2) and FIG. 4 (change in flow velocity). Both figures show a graph based on real measurements, the ordinate of which represents the difference ΔU and the abscissa of which represents the time curve t. The time course of the detected difference ΔU is shown in each case.

In the case in which a bubble BL is located in the second measuring medium MD2 (FIG. 3), the heat dissipation at a given time changes at only one of the heating elements HZ1, HZ2, because the measuring points MS1, MS2 are spatially separated. This means that the difference ΔU between the two voltages U1, U2 will change. Two peaks are shown in the time interval Δt, because the bubble first passes the first measuring point MS1 and then passes the second measuring point MS2. The second peak runs in the negative direction, because the subtraction of the voltages U1 and U2 is not commutative.

In the case of a flow change (FIG. 4), the heat dissipation also changes, but this change takes place simultaneously at both measuring points MS1, MS2; i.e., the difference ΔU remains constant. The method of bubble detection according to the invention is therefore flow-independent. The method according to the invention is applicable to a large number of combinations of media (MD1<->MD2) and is not limited exclusively to bubbles BL (in which the first medium is present in gaseous form). Droplets (the second medium is in liquid form, not capable of mixing with the second medium ML2) can also be reliably detected.

If bubbles BL or droplets occur regularly, the flow rate (time-of-flight) or the flow direction FR can also be inferred (see FIG. 3). With knowledge of the distance d between the two measuring points MS1, MS2 and the measured time Δt between the two peaks, the following holds for the flow velocity v: v=d/Δt.

A combination of a conventional thermal flow sensor (anemometric, calorimetric, or time-of-flight), which usually has two heating elements HZ1, HZ2 is also possible with the method according to the invention. For example, in a first measuring mode such a thermal flow sensor measures the flow rate of the second medium MD2 in the measuring pipe. In a second measuring mode, the method according to the invention is carried out. The thermal flow sensor switches between the two measuring modes at regular intervals, or in alternating fashion.

### LIST OF REFERENCE SIGNS

BL Bubbles
FR Flow direction
HE1 First heating element
HE2 Second heating element
MD1 First medium
MD2 Second medium
MS1 First measuring point
MS2 Second measuring point
R1 First resistor
R2 Second resistor
TS1 First temperature sensor
TS2 Second temperature sensor
U1 First electrical measured variable
U2 Second electrical measured variable
Δt Detected time between changes in the two measured variables
ΔU Difference of the measured values
ΔU_Ref Reference value

1-14. (canceled)

15. A method for detecting bubbles or droplets of a first medium in a fluid second medium flowing through a measuring pipe, the method comprising:
heating a first heating element and a second heating element via electrical power, wherein the first heating element is arranged on the measuring pipe at a first measuring point, and the second heating element is arranged on the measuring pipe at a second measuring point, wherein the second measuring point is a distance from the first measuring point in a direction of flow of the second medium;
simultaneously sensing a first ambient temperature at the first measuring point using a first temperature sensor and a second ambient temperature at the second measuring point using a second temperature sensor, a first electrical measured variable of the first temperature sensor being determined to sense the first ambient temperature, and a second electrical measured variable of the second temperature sensor being determined to sense the second ambient temperature;
calculating a difference between the first electrical measured variable and the second electrical measured variable; and
comparing an absolute value of the difference with a reference threshold value, wherein the presence of a bubble or droplet is detected when the absolute value of the difference at least temporarily exceeds the reference threshold value.

16. The method according to claim 15, wherein the first electrical measured variable is a first voltage drop across the first temperature sensor and/or a first current value flowing through the first temperature sensor, and wherein the second electrical measured variable is a second voltage drop across the second temperature sensor and/or a second current value flowing through the second temperature sensor.

17. The method according to claim 15, further comprising:
detecting a time between a change in the first measured variable and a corresponding change in the second measured variable; and
determining a flow rate of the detected bubble or of the detected droplet and/or the flow direction of the second medium and/or of the bubble or of the droplet is determined based on the detected time and the distance between the first measuring point and the second measuring point.

18. The method according to claim 15, further comprising operating the first temperature sensor as the first heating element, and operating the second temperature sensor as the second heating element.

19. A sensor arrangement comprising a measuring pipe, a first heating element, a second heating element, a first temperature sensor, a second temperature sensor, and a control/evaluation unit,
wherein the control/evaluation unit is configured to control the first heating element, the second heating element, the first temperature sensor and the second temperature sensor as to perform the method according to claim 15.

20. The sensor arrangement according to claim 19, wherein the first temperature sensor is operated as the first heating element, and wherein the second temperature sensor is operated as the second heating element.

21. The sensor element according to claim 20, wherein the first heating element and the second heating element are PCT resistor elements or NTC resistor elements.

22. The sensor arrangement according to claim 19, wherein the first heating element and the first temperature sensor are separate elements, and wherein the second heating element and the second temperature sensor are separate elements.

23. The sensor element according to claim 22, wherein the first heating element and the second heating element, and/or the first temperature sensor and the second temperature sensor, are PCT resistor elements or NTC resistor elements.

24. The sensor element according to claim 22, wherein the first temperature sensor and the second temperature sensor are thermocouples.

25. The sensor arrangement according to claim 22, wherein the first temperature sensor is identical in design to the second temperature sensor.

26. The sensor arrangement according to claim 19, wherein the first heating element is identical in design to the second heating element.

27. The sensor arrangement according to claim 19, wherein the first temperature sensor and the second temperature sensor are arranged in a bridge circuit, wherein a first resistor is connected in series upstream of the first temperature sensor, and wherein a second resistor is connected in series upstream of the second temperature sensor,
wherein the first resistor and the second resistor are identical in design.

28. The sensor arrangement according to claim 19, wherein the measuring pipe is made of an optically non-transparent material.

29. The sensor arrangement according to claim 19, wherein the measuring pipe is made of a metallic material.

30. The sensor arrangement according to claim 19, wherein the first heating element, the second heating element, the first temperature sensor, and the second temperature sensor, or the first temperature sensor operated as a first heating element and the second temperature sensor operated as a second heating element, are arranged on an exterior surface of the measuring pipe.

31. The sensor arrangement according to claim 19, wherein the first heating element, the second heating element, the first temperature sensor and the second temperature sensor, or the first temperature sensor operated as the first heating element and the second temperature sensor operated as the second heating element, are arranged within the measuring pipe.
